(19) United States
(12) Patent Application Publication
(10) Pub. No.: US 2024/0033696 A1
(43) Pub. Date: Feb. 1, 2024

(54) MIXING SYSTEM FOR ALLOWING THE HYDROSTATIC HEAD TO REMAIN CONSTANT AS SCALE INCREASES

(71) Applicant: Newlight Technologies, Inc., Huntington Beach, CA (US)

(72) Inventors: Joshua Hlebak, Long Beach, CA (US); Kenton Kimmel, Huntington Beach, CA (US)

(21) Appl. No.: 18/360,661

(22) Filed: Jul. 27, 2023

Related U.S. Application Data
(60) Provisional application No. 63/393,142, filed on Jul. 28, 2022.

(51) Int. Cl. B01F 27/113; B01F 27/191; B01F 27/85; B01F 27/91

(52) U.S. Cl. CPC B01F 27/113; B01F 27/191; B01F 27/85; B01F 27/91; B01F 2101/2204

(57) ABSTRACT

The present specification generally relates to mixing systems using impellers which entrain gas into the liquid both at the surface and below the surface where it is dispersed into the circulation produced by the impellers. In particular, the invention pertains to the use of multiple vertical agitators in a single fermenter tank to allow the hydrostatic head to remain constant as scale increases, thereby preventing an increase in dissolved carbon dioxide. In addition, multiple agitators allow for wider fermenters without the issue of tip-speed induced bacterial shear.

### RELATED CASES

This application claims priority to U.S. Provisional Patent Application No. 63/393,142, filed Jul. 28, 2022, the entire contents of which is incorporated by reference herein.

### BACKGROUND

An increasing share of the world's chemical production relies on microorganisms or mammalian cells (collectively referred to herein as “cells”) that function as cellular factories for the biosynthesis of a given molecule or product. Stirred-tank reactors (STRs), a specific type of fermenter or bioreactor, function as the “home” to these cellular factories as they support a biologically active environment. Scaling up the size of STRs presents complications in terms of maintaining optimal conditions for cellular function.

### SUMMARY

An STR is commonly cylindrical, ranging in size from liters to cubic meters, and are often made of stainless steel. The design of an STR is a relatively complex engineering task and may even be dependent upon the type of cells that are being grown. Under optimum conditions, the cells are able to perform their desired function with limited production of impurities. The environmental conditions inside the bioreactor, such as temperature, nutrient concentrations, pH, and dissolved gases (especially oxygen for aerobic fermentations) affect the growth and productivity of the cells. The temperature of the fermentation medium is maintained by a cooling jacket, coils, or both. Nutrients may be continuously added to the STR, as in a fed-batch system, or may be charged into the reactor at the beginning of fermentation. The pH of the medium is measured and adjusted with small amounts of acid or base, depending upon the fermentation. For aerobic (and some anaerobic) fermentations, reactant gases (especially oxygen) must be added to the fermentation. Since oxygen is relatively insoluble in water (the basis of nearly all fermentation media), air (or purified oxygen) must be added continuously. The action of the rising bubbles helps mix the fermentation medium and also “strips” out waste gases, such as carbon dioxide.

At the heart of the “home” lies an impeller (in several embodiments, more than one is used), also known as an agitator. It performs the tasks of mixing, aeration, heat and mass transfer within the vessel. To ensure the healthy growth of cells, the impeller needs to stir the mixture of substrate, cells, and oxygen homogenously. Furthermore, selection of the impeller type can impact yield and quality of product. The major parameters to consider are mixing time, power input, dimensions, eddy size, and maximum energy dissipation. All of these factors will impact the homogeneity of the suspension and therefore the heat and mass transfer within the cells, which will ultimately influence the final quality and yield of the product. One issue to consider with STR design is that the power input needed for homogeneous cell distribution generates shear stress that has the potential to cause cell damage. Furthermore, as the working volume of the STR increases the vessel gets taller and as the vessel gets taller the hydrostatic head increases which results in an increase in dissolved carbon dioxide during the fermentation process. One cannot simply increase the diameter of a fermenter to keep the hydrostatic head constant, because eventually the speed of the agitator blades will begin to shear the cells. In addition, there is an upper limit on power for commercially available agitators, so any commercial STR (CSTR) will reach a maximum scale. Furthermore, it is important in some applications to keep the agitation power per gallon of fermenter volume fixed so that the mass transfer remains constant as the scale increases.

Thus, a need exists for providing stirred-tank reactors that are capable of being commercially scaled while allowing hydrostatic head to remain constant thereby preventing an increase in dissolved carbon dioxide (CO₂). In addition, it is a particular object of embodiments disclosed herein to increase mixing, aeration, heat and mass transfer within the vessel without causing physical damage to the cells while not adding unreasonable cost to the manufacturing process of the product.

Embodiments of the present specification generally relate to mixing systems using impellers which entrain gas into the liquid both at the surface and below the surface where it is dispersed into the circulation produced by the impellers. In particular, several embodiments pertain to the use of multiple vertical agitators in a single fermenter tank to allow the hydrostatic head to remain constant as scale increases, thereby preventing an increase in dissolved carbon dioxide. In addition, multiple agitators allow for fermenter having wider diameters without the issue of tip-speed induced cell shear.

Accordingly, it is an object of several embodiments to provide an improved mixing system which provides excellent mixing and mass transfer, while preventing shear and carbon dioxide (dCO₂) poisoning.

It is a still further object of several embodiments to address the need for scaling an STR while maintaining the agitation power per gallon of fermenter volume fixed so that the mass transfer remains constant as the scale increases.

Several embodiments provided for further provide a solution to minimize the increase in hydrostatic head thus maintaining and controlling the dissolved dCO₂ levels during the fermentation process.

In addition, it is a particular object of several embodiments to increase mixing, aeration, heat and mass transfer within the vessel without causing physical damage to the cells while not adding unreasonable cost to the manufacturing process of the product.

In general, several embodiments describe the use of multiple vertical high-powered agitators in a single fermenter to allow the hydrostatic head to remain constant as scale increases, to prevent an increase in dCO₂. In addition, multiple agitators allow for the use of wider fermenters without the issue of tip-speed induced bacterial shear.

The above and other needs are met by placing multiple agitators into a single fermenter. According to one embodiment, multiple the vertical agitators are equally spaced throughout a vessel, and can be either up pumping, down pumping or a combination of up and down pumping impellers providing excellent mixing and mass transfer, while preventing shear and dCO₂ poisoning of the cell culture.

In accordance with one aspect, there is provided a mixing impeller system for synthesizing a molecule or product. In some embodiments the mixing impeller system can include a support structure, a motor, a gearbox, a tank, and at least one mixing impeller assembly. In some embodiments, the tank can include a bottom portion, a top portion, and an opening, wherein the tank is configured to hold a fluid and forms a closed environment. In some embodiments, the at least one mixing impeller can include a shaft comprising an upper end and a lower end, wherein the upper end of the shaft is connected to at least one of the support structure, the motor, and the gearbox. In some embodiments, the at least one mixing impeller can include at least one hub attached to the shaft. In some embodiments, the at least one mixing impeller can include at least one blade, wherein each of the at least one blade is attached to one of the at least one hub.

In other embodiments, the tank is cylindrical. In other embodiments, the cover can be movably attached to the opening of the tank. In other embodiments, the cover is domed. In other embodiments, the closed environment is configured to be pressurized. In other embodiments, the fluid comprises a fermentation media.

In other embodiments, the mixing impeller system can include at least four mixing impeller assemblies. In other embodiments, the mixing impeller system can include at least five mixing impeller assemblies. In other embodiments, each of the at least one mixing impeller assembly is identical to another of the at least one mixing impeller assembly. In other aspects, the at least one mixing impeller assembly comprises different impeller types. In other embodiments each of the at least one mixing impeller assembly varies in size. In other embodiments, each of the at least one mixing impeller assembly varies to generate a desired media flow. In other embodiments, each of the at least one hub of each of the at least one mixing impeller assembly is keyed to the shaft of the at least one mixing impeller assembly. In other embodiments, the lower end of the shaft is journaled in a steady bearing. In other embodiments, each of the at least one hub comprises at least one ear and each of the at least one blade is attached to one of the at least one ear. In other embodiments, each of the at least one ear is circumferentially spaced about each hub of the at least one mixing impeller assembly.

In other embodiments, each of the at least one blade can be a pitch blade. In other embodiments, each of the at least one blade is a marine impeller. In other embodiments, each of the at least one blade is curved and twisted.

In other embodiments, each of the at least one blade comprises a first side facing the top portion of the tank and a second side facing the bottom portion of the tank wherein the first side can be concave and the second side can be convex. In other embodiments, each of the at least one blade is positioned at an angle between 30° to 35° to a central axis of the shaft. In other embodiments, a movement of the at least one mixing impeller assembly is configured to move the fluid in a first direction, toward the top portion of the tank.

In other embodiments, each of the at least one blade comprises a first side facing the top portion of the tank and a second side facing the bottom portion of the tank wherein the first side is convex and the second side is concave. In other embodiments, each of the at least one blade is positioned at an angle between 40° to 50° to a central axis of the shaft. In other embodiments, a movement of the at least one mixing impeller assembly is configured to move the fluid in a second direction, toward the bottom portion of the tank.

In other embodiments, the tank comprises a port to introduce fluid into the tank at a position below a lower-most impeller of the at least one mixing impeller. In other embodiments, the port is a sparge ring.

In other embodiments, each of the at least one mixing impeller assembly is positioned within the tank such that a field of fluid flow of each of the at least one mixing impeller assembly overlaps. In other embodiments, an overlapping of the field of fluid flow of each of the at least one mixing impeller assembly produces an axial flow and/or a radial flow.

In other embodiments, each of the at least one mixing impeller assembly can include at least one baffle to inhibit radial flow and produce a swirling flow. In other embodiments, each of the at least one baffle projects radially inward. In other embodiments, a height of each of the at least one baffle has sufficient spacing between an upper edge of each of the at least one baffle and a lower edge of each of the at least one baffle such that a movement of each of the at least one mixing impeller is not impeded.

In other embodiments, the mixing impeller system is configured to produce at least one of a yeast, fungi, algae, bacteria, and combinations thereof.

In accordance with another aspect, there is provided another embodiment of a mixing impeller system for synthesizing a molecule or product. In some embodiments, the mixing impeller system can include a support structure, a motor, and a gearbox. In some embodiments, the mixing impeller system can include a tank comprising a bottom portion, a top portion, and an opening, wherein the tank is configured to hold a fluid and forms a closed environment. In some embodiments, the mixing impeller system can include a plurality of mixing impeller assemblies. In some embodiments, each of the plurality of mixing impeller assemblies can include a shaft comprising an upper end and a lower end, wherein the upper end of the shaft is connected to at least one of the support structure, the motor, and the gearbox. In some embodiments, each of the plurality of mixing impeller assemblies can include a plurality of hubs attached to the shaft. In some embodiments, each of the plurality of mixing impellers can include a plurality of blades, each of the plurality of blades comprises a first side facing a top portion of the tank and a second side facing the bottom portion of the tank, wherein the first side is concave and the second side is convex. In some embodiments, each of the plurality of blades is attached to one of the plurality of hubs and each of the plurality of blades is positioned at an angle between 30° to 35° to a central axis of the shaft. In some embodiments, a movement of the plurality of mixing impeller assemblies is configured to move the fluid in a first direction, toward a top portion of the tank.

In accordance with another aspect, there is provided another embodiment of a mixing impeller system for synthesizing a molecule or product. In some embodiments, the mixing impeller system can include a support structure, a motor, and a gearbox. In some embodiments, the mixing impeller system can include a tank comprising a bottom portion, a top portion, and an opening, wherein the tank is configured to hold a fluid and forms a closed environment. In some embodiments, the mixing impeller system can include at least one first mixing impeller assembly, each of the at least one of the first mixing impeller assembly. The first mixing impeller assembly can include a first shaft comprising a first upper end and a first lower end, wherein the first upper end of the first shaft is connected to at least one of the support structure, the motor, and the gearbox. In some embodiments, the first mixing impeller assembly can include a plurality of first hubs attached to the first shaft. In some embodiments, the first mixing impeller assembly can include a plurality of first mixing impellers comprising a plurality of first blades, each of the plurality of first blades comprises a first top side facing a top portion of the tank and a first bottom side facing the bottom portion of the tank, wherein the first top side is concave and the first bottom side is convex. In some embodiments, in the first mixing impeller assembly, each of the plurality of first blades is attached to one of the plurality of first hubs and each of the plurality of first blades is positioned at an angle between 30° to 35° to a central axis of the first shaft. In some embodiments, in the first mixing impeller assembly, a movement of the at least one first mixing impeller assemblies is configured to move the fluid in a first direction, toward a top portion of the tank. In some embodiments, the mixing impeller system can include at least one second mixing impeller assembly. The second mixing impeller assembly can include a second shaft comprising a second upper end and a second lower end, wherein the second upper end of the second shaft is connected to at least one of the support structure, the motor, and the gearbox. In some embodiments, the second mixing impeller assembly can include a plurality of second hubs attached to the second shaft. In some embodiments, the second mixing impeller assembly can include a plurality of second mixing impellers comprising a plurality of second blades, each of the plurality of second blades comprises a second top side facing a top portion of the tank and a second bottom side facing the bottom portion of the tank, wherein the second top side is convex and the second bottom side is concave. In some embodiments, in the second mixing impeller assembly, each of the plurality of second blades is attached to one of the plurality of second hubs and each of the plurality of second blades is positioned at an angle between 40° to 50° to a central axis of the second shaft. In some embodiments, in the second mixing impeller assembly, a movement of the at least one second mixing impeller assembly is configured to move the fluid in a second direction, toward a bottom portion of the tank.

In accordance with another aspect, there is provided a mixing system for circulating a liquid in a tank. In some embodiments, the tank has vertically disposed walls having an outer surface and an inner surface. In some embodiments, the mixing system can include two or more impeller assemblies situated vertically within said tank, wherein said impeller assemblies are equally spaced between the diameter of the inner walls of said tank.

In other embodiments, the mixing system can include impeller assemblies that comprise three or more impellers successively spaced circumferentially from each other about the axis, each of said blades having a vertical portion disposed with respect to a radial line extending from said axis to define an acute angle therebetween. In other embodiments, the mixing system can include means for sparging said gas at a plurality of locations selected from locations in the vicinity of the lower most end of said tank. In other embodiments, the mixing system can include impellers for down pumping. In other embodiments, the mixing system can include impellers for up pumping. In other embodiments, the mixing system can include impeller assemblies that are spaced sufficiently close together to provide agitation fields which are coupled or overlap each other. In other embodiments, the mixing system can include a tank that is seeded with a microorganism. In other embodiments, the microorganism is a methanotroph.

Additional embodiments and features are set forth in the description that follows, and in part will become apparent to those skilled in the art upon examination of the specification or may be learned by the practice of the disclosed embodiments. The features and advantages of the disclosed embodiments may be realized and attained by means of the instrumentalities, combinations, and methods described in the specification.

### BRIEF DESCRIPTION OF THE DRAWINGS

A further understanding of the nature and advantages of the disclosed embodiments may be realized by reference to the remaining portions of the specification and the drawings. All drawings are not to scale.

FIG. 1 is a perspective view of an agitator system of up pumping impellers used in the stirred tank reactor system of the present invention. The tank is shown in phantom lines and the support for the impeller system and the motor and gear box are illustrated schematically;

FIG. 2 is a sectional view taken along the line 2-2 in FIG. 1 when viewed in the direction of the arrows;

FIG. 3 is a perspective view of an agitator system of up pumping and one down pumping impellers used in the stirred tank reactor system of the present invention. The tank is shown in phantom lines and the support for the impeller system and the motor and gear box are illustrated schematically; and

FIG. 4 is a sectional view taken along the line 4-4 in FIG. 3 when viewed in the direction of the arrows.

While the embodiments disclosed herein are amenable to various modifications, specifics thereof have been shown by way of in the drawings and will be described in detail in the following more detailed description. It should be understood, however, that the intention is not to limit the claimed invention to the particular embodiments described. On the contrary, the intention is to cover all modifications, equivalents, and alternatives falling within the spirit and scope of the disclosure provided for as defined by the appended claims.

In the appended figures, similar components and/or features may have the same reference label. Further, various components of the same type may be distinguished by following the reference label by a dash and a second label that distinguishes among the similar components. If only the first reference label is listed in the specification, the description is applicable to anyone of the similar components having the same first reference label irrespective of the second reference label.

### DETAILED DESCRIPTION

Although certain preferred embodiments and examples are disclosed below, inventive subject matter extends beyond the specifically disclosed embodiments to other alternative embodiments and/or uses and to modifications and equivalents thereof. Thus, the scope of the presently disclosed invention(s) is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Certain non-limiting embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting embodiments and that the scope of the presently claimed invention is defined by the claims. The features illustrated or described in connection with one embodiment may be combined with the features of other embodiments. Such modifications and variations are intended to be included within the scope of the present technology.

As used herein the term “fermentation” or “fermentation process” shall be given its ordinary meaning and shall also refer to any fermentation process or any process comprising a fermentation step. A fermentation process includes, without limitation, fermentation processes used to produce PHAs and are well known in the art. Examples of such can be found in U.S. Pat. Nos. 7,579,176 and 9,850,508 issued to Herrema, et al., all of which are incorporated herein by reference.

As used herein the term “fermentation media” or “fermentation medium” shall be given its ordinary meaning and shall also refer to the environment in which the fermentation is carried out and which includes the fermentation substrate, that is, the carbon source that is metabolized by the fermenting microorganism. The fermentation media, including fermentation substrate and other raw materials used in the fermentation process may be processed prior to or simultaneously with the fermentation process. Accordingly, the fermentation media can refer to the media before the fermenting microorganisms are added, as well as the media which comprises the fermenting microorganisms.

As used herein the term “fermenting microorganism” shall be given its ordinary meaning and shall also refer to any microorganism suitable for use in a desired fermentation process. Suitable fermenting microorganisms according to the invention are able to ferment, i.e., convert, methane, carbon dioxide, sugars, alkanes, vegetable oils, organic acids, and alcohols, directly or indirectly into the PHA. Sources from which PHA is extracted via the process of the present invention include single-cell organisms such as bacteria or fungi and higher organisms such as plants (herein collectively referred to as “biomass”). While such biomass could be genetically manipulated species, they are preferably wild-type organisms specifically selected for the production of a specific PHA of interest. Bacteria useful in the present invention include any bacteria which naturally produce PHA. To date, Cupriavidus necator (formerly known as Wautersia eutropha, Ralstonia eutropha and Alcaligenes eutrophus) is the most extensively studied microorganism for the cost-effective production of PHA. Numerous other strains such as Bacillus megaterium, Bacillus cereus SPV, Sinorhizobium meliloti, Azotobacter spp, Pseudomonas putida KT2440 and Metylobacterium spp, and Methylococcus spp are also gaining attention for PHA production. These bacteria can accumulate up to 30-90% of their weight as PHB under limiting nitrogen substrate and in the presence of an abundant source of carbon such as, but not limited to, methane, carbon dioxide, sugars, alkanes, vegetable oils, organic acids, and alcohols. For further examples of such bacteria the following articles and patents are incorporated herein by reference—NOVEL BIODEGRADABLE MICROBIAL POLYMERS, E. A. Dawes, ed., NATO ASI Series, Series E: Applied Sciences—Vol. 186, Kluwer Academic Publishers (1990); Herrema, et. al., (U.S. Pat. No. 7,579,176); Shiotani, et. al., (U.S. Pat. No. 5,292,860); and, Peoples, et. al., (U.S. Pat. No. 5,250,430).

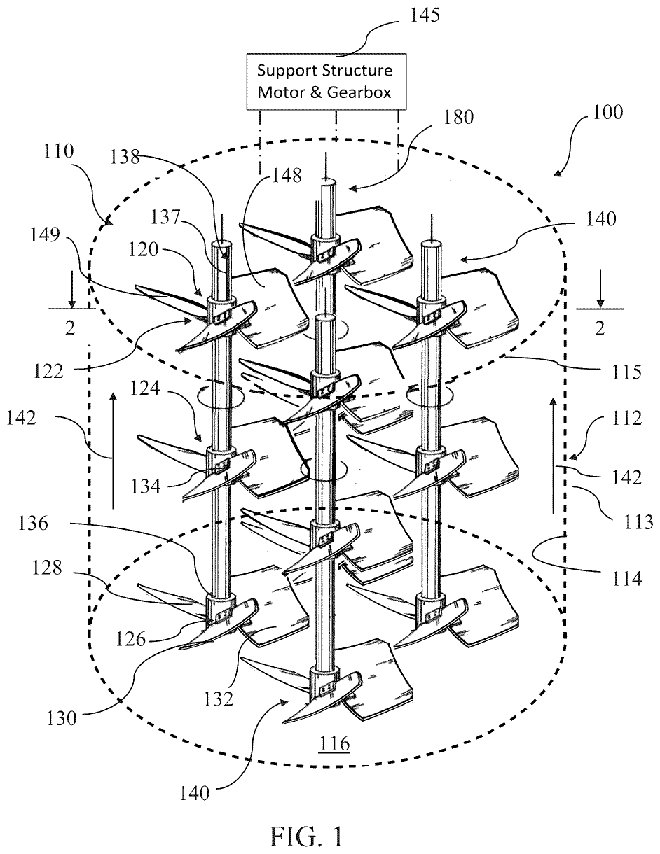

Referring now to FIG. 1, there is shown a mixing impeller system 100 in a tank 110 which may be generally cylindrical and the tank walls 112 arranged vertically upright (or substantially vertically upright) having an outer surface 113 and an inner surface 114. Tank 110 further is closed by a domed top or otherwise (not shown) so that tank 110 is a closed environment capable of also being pressurized. Fermentation media (not shown) is in tank 110 and has a liquid level below the upper end or rim 115 of the tank when the media in the tank is static (that is not being turned over) between the surface and the bottom 116 of the tank. Inner surface 114 provides a zone of a diameter between the inner surface 114 for placement of a plurality of mixing impeller assemblies 120, 140, 160, and 180 of system 100. For the sake of clarity only impeller assembly 120 will be described in further detail; however, it should be understood that the other impeller assemblies 140, 160, and 180 in this particular embodiment are essentially identical. However, in some embodiments, different impeller types, sizes or having a varied configuration may be used together to generate a desired media flow.

Impeller assembly 120 comprises a plurality of mixing impellers 122, 124, and 126 attached via hubs 136 to and driven by a common shaft 138. The hubs may be keyed or otherwise attached to shaft 138. The upper end 137 of shaft 138 may be connected to a support structure, motor, and gearbox 145 and the lower end 139 of shaft 138, may be journaled in a steady bearing (not shown). According to several embodiments, the mixing impellers 122, 124 and 126 are all of the same type. In additional embodiments, there may be employed a mixture of different mixing impellers. In some embodiments, the mixing impellers are pitch blade/marine impellers having a plurality of blades 128, 130, and 132 attached to ears 134 circumferentially spaced about the axis of rotation of hubs 136, the axis being the axis of the shaft 138. In several embodiments, the blades of the mixing impeller are disposed at 33.3° to that axis. Other positions may be used, according to several embodiments, such as when the blades are disposed at about 15° to about 20°, about 20° to about 25°, about 25° to about 30°, about 30° to about 35° (including 30, 31, 32, 33, 34, and 35), about 35° to about 40°, or about 40° to about 45°, and all ranges therebetween, including endpoints (relative to the axis of the shaft 138). By way of non-limiting embodiment, the impellers shown in FIG. 1 are adapted for up pumping operation. That is, they produce axial (or substantially axis) flow in a direction indicated by the arrows 142 toward the surface of the liquid in the tank, which is generally along the axis of rotation of the shaft 138. The blades are curved and twisted plates having concave, pressure sides 148 and convex, suction sides 149.

A sparge ring or comparable port (not shown) for introducing a fluid to be dispersed and mass transferred to the fluid in the tank 110 is disposed below the lower most impeller 126. As a non-limiting embodiment, the fluid in this case a gas, is delivered via a pipe (not shown) into the sparge ring and is released into the tank 110.

It should be understood that while several embodiments provided for herein disclose the use of pitch blade/marine impellers, other impellers depending upon the application can be used. Four classifications exist that allow up or down regulated flow direction: axial flow, radial flow, mixed flow, and distributed flow. One skilled in the art will be able to decide based on the particular need how to choose the appropriate impeller. To ensure healthy growth of cells, the impeller needs to stir the mixture of media, cells, and gases, such as oxygen homogenously, substantially homogenously, or to a degree desired for a particular application.

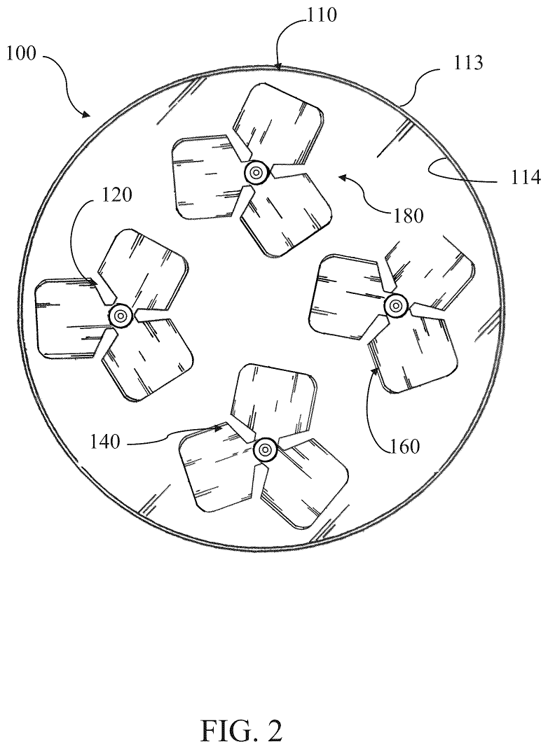

In order to provide uniform mixing throughout tank 110 the impeller assemblies 120, 140, 160, and 180 are spaced sufficiently close to each other so that the field or pattern of their flow overlap, see FIG. 2. When the overlapping fields of flow is created, the agitation produces not only axial, but also significant radial force on the fluid. Baffles (not shown) can be added to inhibit this radial component of flow, which produces a swirling flow. In several embodiments, the baffles project radially inwardly by distances sufficient to inhibit the radial flow of the liquid. Preferably, the height of the baffles is such that the spacing between the upper and lower edges of the baffles and the adjoining impellers is sufficient (e.g., the minimum) that provides a practical running clearance for the impellers 128, 130, and 132.

The following parameters have been found to provide suitable conditions for effective liquid circulation and mixing and mass transfer and oxygenation. It will be appreciated that the specific values which are selected, depend upon the material (liquid, liquid slurry or other medium) being circulated and aerated. It is a feature of the several embodiments of the present invention to provide a mixing system wherein each of these parameters is used so as to secure the benefits of efficient liquid mixing and circulation and effective gas-liquid contacting (mass transfer), especially in bio-reaction processes. The parameters are disclosed below.

### A. Parameters

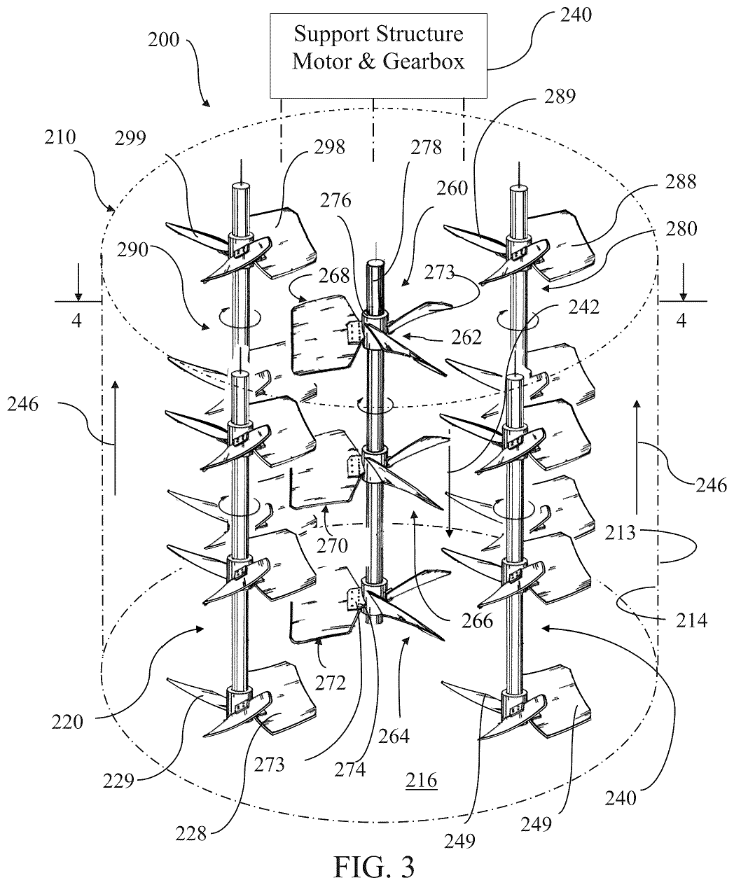

The vertical spacing of the impellers typically is limited to one impeller diameter apart with up pumping or down pumping configuration to avoid staging. Staging occurs when flow is short circuited and the up flow is pulled downward into the bottom of the same impeller. This creates very poor mixing within the tank and adverse reactor performance. The other variables that could impact the vertical spacing are the desired hydrostatic head, impeller diameter, impeller type, power input per an agitator, desired headspace induction (headspace gas pulled downward into the fluid), and the desired concentration of carbon dioxide. An alternate embodiment mixing impeller system 200 of the present invention is shown in FIG. 3, in which five impeller assemblies are positioned within tank 210. Tank 110 which may be generally cylindrical and the tank walls 112 arranged vertically upright having an outer surface 213 and an inner surface 214. Tank 210 further comprises a domed top (not shown) so that tank 210 is a closed environment capable of also being pressurized. Liquid (not shown) is in tank 210 and has a liquid level below the upper end or rim 215 of the tank when the liquid in the tank is static (that is not being turned over) between the surface and the bottom 216 of the tank. Inner surface 214 provides a zone of a diameter between the inner surface 214 for placement of a plurality of mixing impeller assemblies 220, 240, 260, 280, and 290 of system 200. In this particular configuration impeller assemblies 220, 240, 280, and 290 are up pumping and impeller assembly 260 is down pumping. For the sake of clarity only down pumping impeller assembly 260 will be described in further detail; however, it should be understood that the other up pumping impeller assemblies 220, 240, 280, and 290 in this particular embodiment are essentially identical except for the blade configurations. In this instance, the blades on impeller assembly 260 are curved and twisted plates having concave, pressure sides 273 and convex, suction sides 275. The blades on impeller assemblies 220, 240, 280, and 290 are curved and twisted plates having concave, pressure sides 228 and convex, suction sides 229; pressure sides 248 and convex, suction sides 249; pressure sides 288 and convex, suction sides 289; pressure sides 298 and convex, suction sides 299, respectively. These impeller assemblies 220, 240, 280, and 290 are adapted for down pumping operation. That is, they produce axial flow in a direction indicated by the arrow 246 toward the bottom of the liquid in the tank, which is generally along the axis of rotation of the shaft 278.

Impeller assembly 260 comprises a plurality of mixing impellers 262, 264, and 266 attached via hubs 276 to and driven by a common shaft 278. The hubs may be keyed or otherwise attached to shaft 278. The upper end 277 of shaft 278 may be connected to a support structure, motor, and gearbox 240 and the lower end 279 of shaft 278, may be journaled in a steady bearing (not shown). The impellers 262, 264 and 266 are all of the same type, namely so-called pitch blade/marine impellers having a plurality of blades 268, 270, and 272 attached to ears 274 circumferentially spaced about the axis of rotation of hubs 276, the axis being the axis of the shaft 278 and the blades are disposed at 45° to that axis. Other positions may be used, according to several embodiments, such as when the blades are disposed at about 15° to about 20°, about 20° to about 25°, about 25° to about 30°, about 30° to about 35° (including 30, 31, 32, 33, 34, and 35), about 35° to about 40°, about 40° to about 45°, about 45° to about 50°, or about 50° to about 55°, and all ranges therebetween, including endpoints (relative to the axis of the shaft 138). The impellers shown in FIG. 3 are adapted for down pumping operation. That is, they produce axial flow in a direction indicated by the arrow 242 toward the bottom of the liquid in the tank, which is generally along the axis of rotation of the shaft 278.

A sparge ring or comparable port (not shown) for introducing a fluid to be dispersed and mass transferred to the fluid in the tank 210 is disposed below the lower most impeller 266. As a non-limiting embodiment, the fluid in this case a gas, is delivered via a pipe (not shown) into the sparge ring and is released into the tank 210.

As discussed previously, it should be understood that while the certain embodiments disclose the use of pitch blade/marine impellers, other impellers depending upon the application can be used. Four classifications exist that allow up or down regulated flow direction: axial flow, radial flow, mixed flow, and distributed flow. One skilled in the art will be able to decide based on the particular need how to choose the appropriate impeller. To ensure healthy growth of cells, the impeller needs to stir the mixture of substrate, cells, and oxygen homogenously. Furthermore this disclosure is not limited to the use of four or five impeller assemblies, rather the number of impeller assemblies would be dictated by the diameter to the tank that is used.

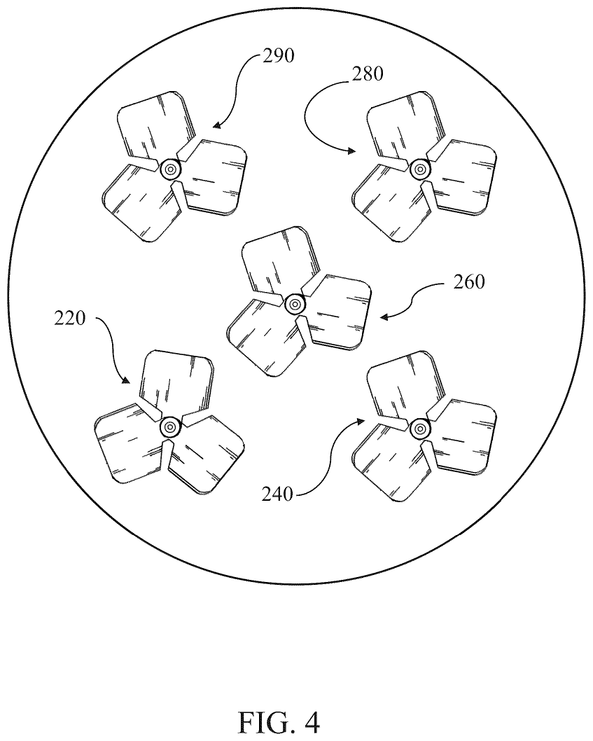

In order to provide uniform mixing throughout tank 210 the impeller assemblies 220, 240, 260, 280, and 290 are spaced sufficiently close to each other so that the field or pattern of their flow overlap, see FIG. 4. In this particular configuration impeller assemblies 220, 240, 280, and 290 are up pumping and impeller assembly 260 is down pumping. This would be the case if the diameter were to increase requiring additional impeller assemblies around the exterior. When the overlapping fields of flow is created, the agitation produces not only axial, but also significant radial force on the fluid. Baffles (not shown) can be added to inhibit this radial component of flow, which produces a swirling flow. The baffles ideally would preferably project radially inwardly by distances sufficient to inhibit the radial flow of the liquid. Preferably, the height of the baffles is such that the spacing between the upper and lower edges of the baffles and the adjoining impellers is the minimum to provide a practical running clearance for the impellers 262, 264 and 266.

In practice, other fermenting microorganism that may be grown in the mixing system according to the present invention may include, but are not limited to, yeast, fungi, algae, and bacteria (including combinations thereof). Suitable yeasts include, but are not limited to, species from the genera Candida, Hansenula, Torulopsis, Saccharomyces, Pichia, 1-Debaryomyces, Lipomyces, Cryptococcus, Nematospora, and Brettanomyces. Suitable genera include Candida, Hansenula, Torulopsis, Pichia, and Saccharomyces. Non-limiting examples of suitable species include, but are not limited to: Candida boidinii, Candida mycoderma, Candida utilis, Candida stellatoidea, Candida robusta, Candida claussenii, Candida rugosa, Brettanomyces petrophilium, Hansenula minuta, Hansenula satumus, Hansenula californica, Hansenula mrakii, Hansenula silvicola, Hansenula polymorpha, Hansenula wickerhamii, Hansenula capsulata, Hansenula glucozyma, Hansenula henricii, Hansenula nonfermentans, Hansenula philodendra, Torulopsis candida, Torulopsis bolmii, Torulopsis versatilis, Torulopsis glabrata, Torulopsis molishiana, Torulopsis nemodendra, Torulopsis nitratophila, Torulopsis pinus, Pichia farinosa, Pichia polymorpha, Pichia membranaefaciens, Pichia pinus, Pichia pastoris, Pichia trehalophila, Saccharomyces cerevisiae, Saccharomyces fragilis, Saccharomyces rosei, Saccharomyces acidifaciens, Saccharomyces elegans, Saccharomyces rouxii, Saccharomyces lactis, and/or Saccharomyces fractum.

Suitable bacteria include, but are not limited to, species from the genera Bacillus, Mycobacterium, Actinomyces, Nocardia, Pseudomonas, Methanomonas, Protaminobacter, Methylococcus, Arthrobacter, Methylomonas, Brevibacterium, Acetobacter, Methylomonas, Brevibacterium, Acetobacter, Micrococcus, Rhodopseudomonas, Corynebacterium, Rhodopseudomonas, Microbacterium, Achromobacter, Methylobacter, Methylosinus, and Methylocystis. Preferred genera include Bacillus, Pseudomonas, Protaminobacter, Micrococcus, Arthrobacter and/or Corynebacterium. Non-limiting examples of suitable species include, but are not limited to: Bacillus subtilus, Bacillus cereus, Bacillus aureus, Bacillus acidi, Bacillus urici, Bacillus coagulans, Bacillus mycoides, Bacillus circulans, Bacillus megaterium, Bacillus licheniformis, Pseudomonas ligustri, Pseudomonas orvilla, Pseudomonas methanica, Pseudomonas fluorescens, Pseudomonas aeruginosa, Pseudomonas oleovorans, Pseudomonas putida, Pseudomonas boreopolis, Pseudomonas pyocyanea, Pseudomonas methylphilus, Pseudomonas brevis, Pseudomonas acidovorans, Pseudomonas methanoloxidans, Pseudomonas aerogenes, Protaminobacter ruber, Corynebacterium simplex, Corynebacterium hydrocarbooxydans, Corynebacterium alkanum, Corynebacterium oleophilus, Corynebacterium hydrocarboclastus, Corynebacterium glutamicum, Corynebacterium viscosus, Corynebacterium dioxydans, Corynebacterium alkanum, Micrococcus cerificans, Micrococcus rhodius, Arthrobacter rufescens, Arthrobacter parafficum, Arthrobacter citreus, Methanomonas methanica, Methanomonas methanooxidans, Methylomonas agile, Methylomonas albus, Methylomonas rubrum, Methylomonas methanolica, Mycobacterium rhodochrous, Mycobacterium phlei, Mycobacterium brevicale, Nocardia salmonicolor, Nocardia minimus, Nocardia corallina, Nocardia butanica, Rhodopseudomonas capsulatus, Microbacterium ammoniaphilum, Archromobacter coagulans, Brevibacterium butanicum, Brevibacterium roseum, Brevibacterium flavum, Brevibacterium lactofermentum, Brevibacterium paraffinolyticum, Brevibacterium ketoglutamicum, and/or Brevibacterium insectiphilium.

In several embodiments, more than one type or species of microorganism is used. For example, in some embodiments, both algae and bacteria are used. In some embodiments, several species of yeast, algae, fungi, and/or bacteria are used. In some embodiments, a single yeast, algae, fungi, and/or bacteria species is used. In some embodiments, a consortium of cyanobacteria is used. In some embodiments, a consortium of methanotrophic microorganisms is used. In still additional embodiments, a consortium of both methanotrophic bacteria and cyanobacteria are used. In several embodiments, methanotrophic, heterotrophic, methanogenic, and/or autotrophic microorganisms are used.

In several embodiments provided for herein, the microorganism culture comprises a consortium of methanotrophic, autotrophic, and/or heterotrophic microorganisms, wherein methane and/or carbon dioxide is individually, interchangeably, or simultaneously utilized for the production of biomass. In several embodiments provided for herein, the microorganism culture comprises methanotrophic microorganisms, cyanobacteria, and non-methanotrophic heterotrophic microorganisms, wherein methane and carbon dioxide are continuously utilized as sources of carbon for the production of biomass and PHA.

In some embodiments, microorganisms are employed in a non-sterile, open, and/or mixed environment. In other embodiments, microorganisms are employed in a sterile and/or controlled environment.

Having disclosed several embodiments, it will be recognized by those skilled in the art that various modifications, alternative constructions, and equivalents may be used without departing from the spirit of the disclosed embodiments. Additionally, a number of well-known processes and elements have not been described in order to avoid unnecessarily obscuring the present invention. Accordingly, the above description should not be taken as limiting the scope of the invention.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a process” includes a plurality of such processes and reference to “the dielectric material” includes reference to one or more dielectric materials and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

What is claimed is:

1. A mixing impeller system for synthesizing a molecule or product, the mixing impeller system comprising:
a support structure;
a motor;
a gearbox;
a tank comprising a bottom portion, a top portion, and an opening, wherein the tank is configured to hold a fluid and forms a closed environment; and
at least one mixing impeller assembly comprising:
a shaft comprising an upper end and a lower end, wherein the upper end of the shaft is connected to at least one of the support structure, the motor, and the gearbox,
at least one hub attached to the shaft,
at least one mixing impeller comprising at least one blade, wherein each of the at least one blade is attached to one of the at least one hub, and
wherein each of the at least one blade comprises a first side facing the top portion of the tank and a second side facing the bottom portion of the tank.

2. The mixing impeller system of claim 1, wherein the tank is cylindrical and comprises a cover movably attached to the opening of the tank.

3. The mixing impeller system of claim 1, wherein the closed environment is configured to be pressurized.

4. The mixing impeller system of claim 1 comprising at least four mixing impeller assemblies.

5. The mixing impeller system of claim 1, wherein each of the at least one hub of each of the at least one mixing impeller assembly is keyed to the shaft of the at least one mixing impeller assembly and wherein the lower end of the shaft is journaled in a steady bearing.

6. The mixing impeller system of claim 1, wherein each of the at least one hub comprises at least one ear and each of the at least one blade is attached to one of the at least one ear, and wherein each of the at least one ear is circumferentially spaced about each hub of the at least one mixing impeller assembly.

7. The mixing impeller system of claim 1, wherein each of the at least one blade is a pitch blade or a marine impeller.

8. The mixing impeller system of claim 1, wherein the first side is concave and the second side is convex, wherein each of the at least one blade is positioned at an angle between 30° to 35° to a central axis of the shaft, and wherein a movement of the at least one mixing impeller assembly is configured to move the fluid in a first direction, toward the top portion of the tank.

9. The mixing impeller system of claim 1, wherein the first side is convex and the second side is concave, wherein each of the at least one blade is positioned at an angle between to 50° to a central axis of the shaft, and wherein a movement of the at least one mixing impeller assembly is configured to move the fluid in a second direction, toward the bottom portion of the tank.

10. The mixing impeller system of claim 1, wherein the tank comprises a port to introduce fluid into the tank at a position below a lower-most impeller of the at least one mixing impeller.

11. The mixing impeller system of claim 1, wherein each of the at least one mixing impeller assembly is positioned within the tank such that a field of fluid flow of each of the at least one mixing impeller assembly overlaps.

12. The mixing impeller system of claim 1, wherein each of the at least one mixing impeller assembly can include at least one baffle to inhibit radial flow and produce a swirling flow, and wherein each of the at least one baffle projects radially inward.

13. A mixing impeller system for synthesizing a molecule or product, the mixing impeller system comprising:
a support structure;
a motor;
a gearbox;
a tank comprising a bottom portion, a top portion, and an opening, wherein the tank is configured to hold a fluid and forms a closed environment; and
a plurality of mixing impeller assemblies, each of the plurality of mixing impeller assemblies comprising:
a shaft comprising an upper end and a lower end, wherein the upper end of the shaft is connected to at least one of the support structure, the motor, and the gearbox,
a plurality of hubs attached to the shaft,
a plurality of mixing impellers comprising a plurality of blades, each of the plurality of blades comprises a first side facing a top portion of the tank and a second side facing the bottom portion of the tank, wherein the first side is concave and the second side is convex,
wherein each of the plurality of blades is attached to one of the plurality of hubs and each of the plurality of blades is positioned at an angle between 30° to 35° to a central axis of the shaft, and
wherein a movement of the plurality of mixing impeller assemblies is configured to move the fluid in a first direction, toward a top portion of the tank.

14. The mixing impeller system of claim 13, wherein the tank is cylindrical and further comprises a cover movably attached to the opening of the tank,

15. The mixing impeller system of claim 13, wherein the hub of each of the plurality of mixing impeller assemblies is keyed to the shaft of each of the plurality of mixing impeller assemblies, and wherein the lower end of the shaft is journaled in a steady bearing.

16. The mixing impeller system of claim 13, wherein the hub comprises a plurality of ears and each of the plurality of blades are attached to each of the plurality of ears, and wherein the plurality of ears are circumferentially spaced about each hub of the plurality of mixing impeller assemblies.

17. A mixing impeller system for synthesizing a molecule or product, the mixing impeller system comprising:
a support structure;
a motor;
a gearbox;
a tank comprising a bottom portion, a top portion, and an opening, wherein the tank is configured to hold a fluid and forms a closed environment; and
at least one first mixing impeller assembly, each of the at least one of the first mixing impeller assembly comprising:
a first shaft comprising a first upper end and a first lower end, wherein the first upper end of the first shaft is connected to at least one of the support structure, the motor, and the gearbox,
a plurality of first hubs attached to the first shaft,
a plurality of first mixing impellers comprising a plurality of first blades, each of the plurality of first blades comprises a first top side facing a top portion of the tank and a first bottom side facing the bottom portion of the tank, wherein the first top side is concave and the first bottom side is convex,
wherein each of the plurality of first blades is attached to one of the plurality of first hubs and each of the plurality of first blades is positioned at an angle between 30° to 35° to a central axis of the first shaft, and
wherein a movement of the at least one first mixing impeller assemblies is configured to move the fluid in a first direction, toward a top portion of the tank.
at least one second mixing impeller assembly, each of the at least one second mixing impeller assembly comprising:
a second shaft comprising a second upper end and a second lower end,
wherein the second upper end of the second shaft is connected to at least one of the support structure, the motor, and the gearbox,
a plurality of second hubs attached to the second shaft,
a plurality of second mixing impellers comprising a plurality of second blades, each of the plurality of second blades comprises a second top side facing a top portion of the tank and a second bottom side facing the bottom portion of the tank, wherein the second top side is convex and the second bottom side is concave,
wherein each of the plurality of second blades is attached to one of the plurality of second hubs and each of the plurality of second blades is positioned at an angle between 40° to 50° to a central axis of the second shaft, and
wherein a movement of the at least one second mixing impeller assembly is configured to move the fluid in a second direction, toward a bottom portion of the tank.

18. The mixing impeller system of claim 17, wherein the tank is cylindrical and further comprises a cover movably attached to the opening of the tank,

19. The mixing impeller system of claim 17, wherein the hub of each of the plurality of mixing impeller assemblies is keyed to the shaft of each of the plurality of mixing impeller assemblies, and wherein the lower end of the shaft is journaled in a steady bearing.

20. The mixing impeller system of claim 17, wherein the hub comprises a plurality of ears and each of the plurality of blades are attached to each of the plurality of ears, and wherein the plurality of ears are circumferentially spaced about each hub of the plurality of mixing impeller assemblies.
